(19) United States
(12) Patent Application Publication
(10) Pub. No.: US 2011/0112888 A1
(43) Pub. Date: May 12, 2011

(54) Marketing and advertising systems

(75) Inventors: Clifford Schinkel, Scappoose, OR (US); John Balloun, Portland, OR (US)

(73) Assignee: AdSwift, LLC, Lincoln City, OR (US)

(21) Appl. No.: 12/220,693

(22) Filed: Jul. 25, 2008

Related U.S. Application Data
(60) Provisional application No. 60/961,932, filed on Jul. 25, 2007.

(51) Int. Cl. G06Q 30/00

(52) U.S. Cl. 705/7.29

(57) ABSTRACT

A method includes submitting marketing media to a media submission system, adapting the submitted media to a specification, and generating marketing output based on the submitted media and the specification. Another method includes operating an online marketing resource system, and facilitating collaboration of different types of users of the marketing resource system. An additional method includes procuring marketing media through a media submission system, and consigning the marketing media through peer-to-peer interaction on the system. A further method includes deploying marketing media through an online marketing resource system, collecting and storing empirical marketing data that relates to specific media content deployed through the system, and correlating the specific media content to target demographics. Another method includes operating an online marketing media creation system, and creating the marketing media through a combination of rules-based input sources.

### CROSS-REFERENCE TO RELATED APPLICATIONS

This application claims priority from U.S. Provisional Patent Application Ser. No. 60/961,932 filed Jul. 25, 2007 which is incorporated by reference.

### COPYRIGHTS

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### COMPUTER PROGRAM LISTING

A computer program listing appendix on compact disc is included in the application and is incorporated by reference. A total of two identical compact discs (Copy 1 and Copy 2) are included. The names of the files on each compact disc, their date of creation, and their size in bytes are as follows:

Directory of E:\

| | | | | |
|---|---|---|---|---|
| 01/03/2008 | 01:01 PM | | 905 | Example_List_Format.txt |
| 01/03/2008 | 01:01 PM | | 15,078 | about_adswift.php |
| 01/03/2008 | 01:01 PM | | 7,558 | account_descriptions.php |
| 01/03/2008 | 01:01 PM | | 31,522 | account_descriptionsOLD.php |
| 01/03/2008 | 01:01 PM | | 1,235 | accounts.css |
| 01/03/2008 | 01:01 PM | | 21,640 | accounts_header.inc |
| 01/03/2008 | 01:01 PM | | 378 | ad_strategies.php |
| 01/03/2008 | 01:01 PM | | 11,316 | adswift.ini |
| 01/03/2008 | 01:01 PM | | 17 | adswift.txt |
| 01/03/2008 | 01:01 PM | | 10,900 | adswift_style.css |
| 01/03/2008 | 01:01 PM | | 5,287 | advanced_options.php |
| 01/03/2008 | 01:01 PM | | 3,297 | backup_site.php |
| 01/03/2008 | 01:01 PM | | 3,671 | banner.php |
| 01/03/2008 | 01:01 PM | | 46 | blank.txt |
| 01/03/2008 | 01:01 PM | | 5,344 | breakdown.php |
| 01/03/2008 | 01:01 PM | | 19,433 | business_form.php |
| 01/03/2008 | 01:01 PM | | 11,499 | calendar.php |
| 01/03/2008 | 01:01 PM | | 9,911 | calendar_old.php |
| 01/03/2008 | 01:01 PM | | 611 | change_perm.php |
| 01/03/2008 | 01:01 PM | | 9,253 | color_printing.php |
| 01/03/2008 | 01:01 PM | | 518 | confirmation.php |
| 01/03/2008 | 01:01 PM | | 11,034 | contact.php |
| 01/03/2008 | 01:01 PM | | 19,518 | createAccount.php |
| 01/03/2008 | 01:01 PM | | 12,933 | createAccount_5.4.04.php |
| 01/03/2008 | 01:01 PM | | 20,480 | createXML.php |
| 01/03/2008 | 01:01 PM | | 13,374 | createXML_evan.php |
| 01/03/2008 | 01:01 PM | | 13,374 | createXML_old.php |
| 01/03/2008 | 01:01 PM | | 1,354 | create_company_directories.php |
| 01/03/2008 | 01:01 PM | | 26,605 | create_orders.php |
| 01/03/2008 | 01:01 PM | | 25,350 | create_orders_orig.php |
| 01/03/2008 | 01:01 PM | | 1,003 | create_user_directories.php |
| 01/03/2008 | 01:01 PM | | 2,653 | creditExpiredPromos.php |
| 01/03/2008 | 01:01 PM | | 665 | customInfoPopUp.php |
| 01/03/2008 | 01:01 PM | | 28,838 | database.php |
| 01/03/2008 | 01:01 PM | | 5,847 | dates.php |
| 01/03/2008 | 01:01 PM | | 114 | deleteme.php |
| 01/03/2008 | 01:01 PM | | 9,401 | design_services.php |
| 01/03/2008 | 01:01 PM | | 22,978 | designer_form.php |
| 01/03/2008 | 01:01 PM | | 15,214 | displayOrderInformation.php |
| 01/03/2008 | 01:01 PM | | 4,389 | displayPostcard.php |
| 01/03/2008 | 01:01 PM | | 8,631 | dynamic_drop_menu.inc |
| 01/03/2008 | 01:01 PM | | 31,942 | editAccount.php |
| 01/03/2008 | 01:01 PM | | 16,660 | editAccountFunctions.inc |
| 01/03/2008 | 01:01 PM | | 369 | feedback_thanks.php |
| 01/03/2008 | 01:01 PM | | 1,027 | fix_order.php |
| 01/03/2008 | 01:01 PM | | 140 | foo.php |
| 01/03/2008 | 01:01 PM | | 1,098 | footer.inc |
| 01/03/2008 | 01:01 PM | | 523 | footer_new.inc |
| 01/03/2008 | 01:01 PM | | 21,101 | formTarget.php |
| 01/03/2008 | 01:01 PM | | 2,246 | form_includes.php |
| 01/03/2008 | 01:01 PM | | 0 | fsg11df0.txt |
| 01/03/2008 | 01:01 PM | | 516 | hasAccount.php |
| 01/03/2008 | 01:01 PM | | 22,398 | header.inc |
| 01/03/2008 | 01:01 PM | | 10,051 | header_new.inc |
| 01/03/2008 | 01:01 PM | | 330 | image.php |
| 01/03/2008 | 01:01 PM | | 14,542 | imageBank_delete.php |
| 01/03/2008 | 01:01 PM | | 1,040 | imagePopUp_delete.php |
| 01/03/2008 | 01:01 PM | | 19,104 | index-old.php |
| 01/03/2008 | 01:01 PM | | 570 | index.php |
| 01/03/2008 | 01:01 PM | | 21 | info.php |
| 01/03/2008 | 01:01 PM | | 895 | list_dirs.php |
| 01/03/2008 | 01:01 PM | | 2,425 | list_specs.php |
| 01/03/2008 | 01:01 PM | | 2,474 | live_to_dev.php |
| 01/03/2008 | 01:01 PM | | 1,621 | login.php |
| 01/03/2008 | 01:01 PM | | 648 | logout.php |
| 01/03/2008 | 01:01 PM | | 8,873 | mail.php |
| 01/03/2008 | 01:01 PM | | 1,874 | mailRepresentative.php |
| 01/03/2008 | 01:01 PM | | 522 | mail_confirmation.php |
| 01/03/2008 | 01:01 PM | | 376 | managers_plans.php |
| 01/03/2008 | 01:01 PM | | 5,917 | mass_mail.php |
| 01/03/2008 | 01:01 PM | | 9,004 | newAccount.php |
| 01/03/2008 | 01:01 PM | | 5,418 | newAccount_5.4.04.php |
| 01/03/2008 | 01:01 PM | | 10,883 | opportunities.php |
| 01/03/2008 | 01:01 PM | | 9,785 | order_data_generator.php |
| 01/03/2008 | 01:01 PM | | 3,164 | parse_xml_orders.php |
| 01/03/2008 | 01:01 PM | | 1,048 | pdfTesting.php |
| 01/03/2008 | 01:01 PM | | 79,451 | php_init.inc |
| 01/03/2008 | 01:01 PM | | 1,783 | postTest.php |
| 01/03/2008 | 01:01 PM | | 6,616 | postcard_specs.php |
| 01/03/2008 | 01:01 PM | | 8,477 | postcard_specs_designer.php |
| 01/03/2008 | 01:01 PM | | 3,213 | pphlogger.js |
| 01/03/2008 | 01:01 PM | | 280 | printPost.php |
| 01/03/2008 | 01:01 PM | | 316 | printdb.php |
| 01/03/2008 | 01:01 PM | | 23,511 | private_form.php |
| 01/03/2008 | 01:01 PM | | 11,112 | providers_login.php |
| 01/03/2008 | 01:01 PM | | 85 | real_path.php |
| 01/03/2008 | 01:01 PM | | 3,866 | reviewAccount.php |
| 01/03/2008 | 01:01 PM | | 1,727 | shippingDetailsPopUp.php |
| 01/03/2008 | 01:01 PM | | 4,049 | sitemap.xml |
| 01/03/2008 | 01:01 PM | | 19,499 | step1.php |
| 01/03/2008 | 01:01 PM | | 31,554 | step2.php |
| 01/03/2008 | 01:01 PM | | 28,446 | step22.php |
| 01/03/2008 | 01:01 PM | | 20,427 | step3.php |
| 01/03/2008 | 01:01 PM | | 19,701 | step3_old.php |
| 01/03/2008 | 01:01 PM | | 21,162 | step3_special.php |
| 01/03/2008 | 01:01 PM | | 20,144 | step4.php |
| 01/03/2008 | 01:01 PM | | 16,959 | step4_20060409.php |
| 01/03/2008 | 01:01 PM | | 13,756 | step4_new.php |
| 01/03/2008 | 01:01 PM | | 14,661 | step4_old.php |
| 01/03/2008 | 01:01 PM | | 42,633 | step5.php |
| 01/03/2008 | 01:01 PM | | 17,992 | step5_old.php |
| 01/03/2008 | 01:01 PM | | 28,413 | step6.php |
| 01/03/2008 | 01:01 PM | | 17,219 | step6_new.php |
| 01/03/2008 | 01:01 PM | | 20,718 | stepX.php |
| 01/03/2008 | 01:01 PM | | 10,888 | support.php |
| 01/03/2008 | 01:01 PM | | 3,241 | sys_test.php |
| 01/03/2008 | 01:01 PM | | 812 | table_rounded_bottom.inc |
| 01/03/2008 | 01:01 PM | | 990 | table_rounded_top.inc |
| 01/03/2008 | 01:01 PM | | 3,747 | temp.txt |
| 01/03/2008 | 01:01 PM | | 831 | temp2.txt |
| 01/03/2008 | 01:01 PM | | 1,147 | template.php |
| 01/03/2008 | 01:01 PM | | 2,927 | template2_pdf_regular.php |
| 01/03/2008 | 01:02 PM | <DIR> | | templates |
| 01/03/2008 | 01:01 PM | | 708 | test.php |
| 01/03/2008 | 01:01 PM | | 289 | test_for_pdfs.php |
| 01/03/2008 | 01:01 PM | | 5,120 | tmp_adswift_images.txt |
| 01/03/2008 | 01:02 PM | <DIR> | | tools |
| 01/03/2008 | 01:01 PM | | 11,423 | updateAccount.php |
| 01/03/2008 | 01:01 PM | | 5,983 | why_postcards.php |
| 01/03/2008 | 01:01 PM | | 2,447 | xml_prepopulate.php |

| | | |
|---|---|---|
| 118 File(s) | 1,150,102 | bytes |

Directory of E:\templates

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:00 PM | | 114,011 | Copy of class.pdf.php |
| 01/03/2008 | 01:00 PM | | 114,011 | class.pdf.php |
| 01/03/2008 | 01:00 PM | | 79,856 | class.pdf_007.php |
| 01/03/2008 | 01:00 PM | | 111,924 | class.pdf_008.php |
| 01/03/2008 | 01:00 PM | | 17,440 | createXML.php |
| 01/03/2008 | 01:00 PM | | 14,638 | create_orders.php |
| 01/03/2008 | 01:00 PM | | 4,233 | create_pdf.php |
| 01/03/2008 | 01:00 PM | | 4,061 | create_proof.php |
| 01/03/2008 | 01:00 PM | | 62,780 | database.php |
| 01/03/2008 | 01:00 PM | | 666 | ec_template_1.inc |
| 01/03/2008 | 01:02 PM | <DIR> | | generator |
| 01/03/2008 | 01:00 PM | | 13,431 | managePostcard2.php |
| 01/03/2008 | 01:00 PM | | 1,902 | pdf_constants.php |
| 01/03/2008 | 01:00 PM | | 688 | pdf_constructor.php |
| 01/03/2008 | 01:00 PM | | 1,234 | pdf_crop_marks.php |
| 01/03/2008 | 01:00 PM | | 4,910 | pdf_generator.php |
| 01/03/2008 | 01:00 PM | | 3,277 | pdf_overlay.php |
| 01/03/2008 | 01:00 PM | | 123 | pdf_size_jumbo.php |
| 01/03/2008 | 01:00 PM | | 126 | pdf_size_regular.php |
| 01/03/2008 | 01:00 PM | | 2,845 | pdf_underlay.php |
| 01/03/2008 | 01:00 PM | | 4,092 | template.php |
| 01/03/2008 | 01:00 PM | | 18,890 | template1.php |
| 01/03/2008 | 01:00 PM | | 9,707 | template10.php |
| 01/03/2008 | 01:00 PM | | 2,898 | template10_database.php |
| 01/03/2008 | 01:00 PM | | 562 | template10_help.php |
| 01/03/2008 | 01:00 PM | | 1,312 | template10_managePostcard.php |
| 01/03/2008 | 01:00 PM | | 1,599 | template10_pdf_data.php |
| 01/03/2008 | 01:00 PM | | 4,711 | template10_pdf_jumbo.php |
| 01/03/2008 | 01:00 PM | | 5,766 | template10_pdf_regular.php |
| 01/03/2008 | 01:00 PM | | 2,036 | template10_preview.php |
| 01/03/2008 | 01:00 PM | | 931 | template1_help.php |
| 01/03/2008 | 01:00 PM | | 1,621 | template1_managePostcard.php |
| 01/03/2008 | 01:00 PM | | 3,107 | template1_pdf_data.php |
| 01/03/2008 | 01:00 PM | | 2,081 | template1_pdf_jumbo.php |
| 01/03/2008 | 01:00 PM | | 2,298 | template1_pdf_regular.php |
| 01/03/2008 | 01:00 PM | | 4,866 | template1_preview.php |
| 01/03/2008 | 01:00 PM | | 5,231 | template1_static.php |
| 01/03/2008 | 01:00 PM | | 3,892 | template1_xml.inc |
| 01/03/2008 | 01:00 PM | | 10,554 | template2.php |
| 01/03/2008 | 01:00 PM | | 8,480 | template20.php |
| 01/03/2008 | 01:00 PM | | 2,760 | template20_database.php |
| 01/03/2008 | 01:00 PM | | 433 | template20_help.php |
| 01/03/2008 | 01:00 PM | | 818 | template20_managePostcard.php |
| 01/03/2008 | 01:00 PM | | 1,539 | template20_pdf_data.php |
| 01/03/2008 | 01:00 PM | | 5,118 | template20_pdf_jumbo.php |
| 01/03/2008 | 01:00 PM | | 6,003 | template20_pdf_regular.php |
| 01/03/2008 | 01:00 PM | | 4,138 | template20_preview.php |
| 01/03/2008 | 01:00 PM | | 8,654 | template21.php |
| 01/03/2008 | 01:00 PM | | 4,957 | template21_database.php |
| 01/03/2008 | 01:00 PM | | 427 | template21_help.php |
| 01/03/2008 | 01:00 PM | | 1,484 | template21_managePostcard.php |
| 01/03/2008 | 01:00 PM | | 1,700 | template21_pdf_data.php |
| 01/03/2008 | 01:00 PM | | 4,458 | template21_pdf_jumbo.php |
| 01/03/2008 | 01:00 PM | | 5,167 | template21_pdf_regular.php |
| 01/03/2008 | 01:00 PM | | 4,546 | template21_preview.php |
| 01/03/2008 | 01:00 PM | | 4,092 | template23.php |
| 01/03/2008 | 01:00 PM | | 837 | template23_database.php |
| 01/03/2008 | 01:00 PM | | 433 | template23_help.php |
| 01/03/2008 | 01:00 PM | | 189 | template23_managePostcard.php |
| 01/03/2008 | 01:00 PM | | 317 | template23_pdf_data.php |
| 01/03/2008 | 01:00 PM | | 1,902 | template23_pdf_jumbo.php |
| 01/03/2008 | 01:00 PM | | 1,908 | template23_pdf_regular.php |
| 01/03/2008 | 01:00 PM | | 768 | template23_preview.php |
| 01/03/2008 | 01:00 PM | | 3,856 | template2_database.php |
| 01/03/2008 | 01:00 PM | | 524 | template2_help.php |
| 01/03/2008 | 01:00 PM | | 801 | template2_managePostcard.php |
| 01/03/2008 | 01:00 PM | | 1,967 | template2_pdf_data.php |
| 01/03/2008 | 01:00 PM | | 2,765 | template2_pdf_jumbo.php |
| 01/03/2008 | 01:00 PM | | 2,846 | template2_pdf_regular.php |
| 01/03/2008 | 01:00 PM | | 2,294 | template2_preview.php |
| 01/03/2008 | 01:00 PM | | 4,680 | template2_static.php |
| 01/03/2008 | 01:00 PM | | 1,815 | template2_xml.inc |
| 01/03/2008 | 01:00 PM | | 12,922 | template3.php |
| 01/03/2008 | 01:00 PM | | 4,680 | template3_static.php |
| 01/03/2008 | 01:00 PM | | 3,652 | template3_xml.inc |
| 01/03/2008 | 01:00 PM | | 8,363 | template4.php |
| 01/03/2008 | 01:00 PM | | 3,858 | template4_database.php |
| 01/03/2008 | 01:00 PM | | 526 | template4_help.php |
| 01/03/2008 | 01:00 PM | | 801 | template4_managePostcard.php |
| 01/03/2008 | 01:00 PM | | 1,907 | template4_pdf_data.php |
| 01/03/2008 | 01:00 PM | | 4,157 | template4_pdf_jumbo.php |
| 01/03/2008 | 01:00 PM | | 4,232 | template4_pdf_regular.php |
| 01/03/2008 | 01:00 PM | | 2,246 | template4_preview.php |
| 01/03/2008 | 01:00 PM | | 4,680 | template4_static.php |
| 01/03/2008 | 01:00 PM | | 1,816 | template4_xml.inc |
| 01/03/2008 | 01:00 PM | | 6,991 | template5.php |
| 01/03/2008 | 01:00 PM | | 5,618 | template5_database.php |
| 01/03/2008 | 01:00 PM | | 528 | template5_help.php |
| 01/03/2008 | 01:00 PM | | 1,491 | template5_managePostcard.php |
| 01/03/2008 | 01:00 PM | | 1,806 | template5_pdf_data.php |
| 01/03/2008 | 01:00 PM | | 3,716 | template5_pdf_jumbo.php |
| 01/03/2008 | 01:00 PM | | 4,430 | template5_pdf_regular.php |
| 01/03/2008 | 01:00 PM | | 2,381 | template5_preview.php |
| 01/03/2008 | 01:00 PM | | 14,134 | template6.php |
| 01/03/2008 | 01:00 PM | | 10,935 | template6_database.php |
| 01/03/2008 | 01:00 PM | | 424 | template6_help.php |
| 01/03/2008 | 01:00 PM | | 3,307 | template6_managePostcard.php |
| 01/03/2008 | 01:00 PM | | 3,870 | template6_pdf_data.php |
| 01/03/2008 | 01:00 PM | | 5,222 | template6_pdf_jumbo.php |
| 01/03/2008 | 01:00 PM | | 5,222 | template6_pdf_regular.php |
| 01/03/2008 | 01:00 PM | | 4,594 | template6_preview.php |
| 01/03/2008 | 01:00 PM | | 11,112 | template7.php |
| 01/03/2008 | 01:00 PM | | 1,070 | template7_database.php |
| 01/03/2008 | 01:00 PM | | 424 | template7_help.php |
| 01/03/2008 | 01:00 PM | | 189 | template7_managePostcard.php |
| 01/03/2008 | 01:00 PM | | 2,798 | template7_pdf_data.php |
| 01/03/2008 | 01:00 PM | | 4,142 | template7_pdf_jumbo.php |
| 01/03/2008 | 01:00 PM | | 4,142 | template7_pdf_regular.php |
| 01/03/2008 | 01:00 PM | | 3,231 | template7_preview.php |
| 01/03/2008 | 01:00 PM | | 10,131 | template8.php |
| 01/03/2008 | 01:00 PM | | 5,330 | template8_database.php |
| 01/03/2008 | 01:00 PM | | 422 | template8_help.php |
| 01/03/2008 | 01:00 PM | | 1,539 | template8_managePostcard.php |
| 01/03/2008 | 01:00 PM | | 1,778 | template8_pdf_data.php |
| 01/03/2008 | 01:00 PM | | 3,427 | template8_pdf_jumbo.php |
| 01/03/2008 | 01:00 PM | | 4,040 | template8_pdf_regular.php |
| 01/03/2008 | 01:00 PM | | 2,838 | template8_preview.php |
| 01/03/2008 | 01:00 PM | | 9,817 | template9.php |
| 01/03/2008 | 01:00 PM | | 4,981 | template9_database.php |
| 01/03/2008 | 01:00 PM | | 591 | template9_help.php |
| 01/03/2008 | 01:00 PM | | 1,520 | template9_managePostcard.php |
| 01/03/2008 | 01:00 PM | | 2,004 | template9_pdf_data.php |
| 01/03/2008 | 01:00 PM | | 5,556 | template9_pdf_jumbo.php |
| 01/03/2008 | 01:00 PM | | 6,163 | template9_pdf_regular.php |
| 01/03/2008 | 01:00 PM | | 2,497 | template9_preview.php |
| 01/03/2008 | 01:00 PM | | 1,234 | template_crop_marks.php |
| 01/03/2008 | 01:00 PM | | 837 | template_database.php |
| 01/03/2008 | 01:00 PM | | 413 | template_help.php |
| 01/03/2008 | 01:00 PM | | 189 | template_managePostcard.php |
| 01/03/2008 | 01:00 PM | | 2,921 | template_overlay.php |
| 01/03/2008 | 01:00 PM | | 317 | template_pdf_data.php |
| 01/03/2008 | 01:00 PM | | 1,902 | template_pdf_jumbo.php |
| 01/03/2008 | 01:00 PM | | 1,908 | template_pdf_regular.php |
| 01/03/2008 | 01:00 PM | | 1,652 | template_preview.php |
| 01/03/2008 | 01:00 PM | | 4,931 | test_data.php |
| 01/03/2008 | 01:00 PM | | 651 | test_for_pdfs.php |
| 01/03/2008 | 01:00 PM | | 301 | test_to_live_checklist.txt |

| | | |
|---|---|---|
| 136 File(s) | 966,493 | bytes |

Directory of E:\templates\generator

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:00 PM | | 7,038 | Generate_Template_Files.php |
| 01/03/2008 | 01:02 PM | <DIR> | | _file_X2 |
| 01/03/2008 | 01:00 PM | | 137 | clearSession.php |
| 01/03/2008 | 01:00 PM | | 1,767 | form1.php |
| 01/03/2008 | 01:00 PM | | 3,688 | form2.php |
| 01/03/2008 | 01:00 PM | | 5,643 | form3.php |
| 01/03/2008 | 01:00 PM | | 8,881 | form4.php |
| 01/03/2008 | 01:00 PM | | 9,919 | form5.php |
| 01/03/2008 | 01:00 PM | | 927 | getTemplate.php |
| 01/03/2008 | 01:00 PM | | 66 | index.php |
| 01/03/2008 | 01:00 PM | | 776 | loadSession.php |
| 01/03/2008 | 01:02 PM | <DIR> | | output2 |
| 01/03/2008 | 01:00 PM | | 1,292 | printSession.php |

| | | |
|---|---|---|
| 11 File(s) | 40,134 | bytes |

Directory of E:\templates\generator\_file_X2

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:00 PM | | 6,712 | templateX.php |
| 01/03/2008 | 01:00 PM | | 3,335 | templateX_database.php |
| 01/03/2008 | 01:00 PM | | 500 | templateX_help.php |
| 01/03/2008 | 01:00 PM | | 972 | templateX_managePostcard.php |
| 01/03/2008 | 01:00 PM | | 1,510 | templateX_pdf_data.php |
| 01/03/2008 | 01:00 PM | | 3,379 | templateX_pdf_jumbo.php |
| 01/03/2008 | 01:00 PM | | 3,513 | templateX_pdf_regular.php |
| 01/03/2008 | 01:00 PM | | 3,865 | templateX_preview.php |

| | | |
|---|---|---|
| 8 File(s) | 23,786 | bytes |

Directory of E:\templates\generator\output2

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:00 PM | | 8,003 | template10.php |
| 01/03/2008 | 01:00 PM | | 2,923 | template10_database.php |
| 01/03/2008 | 01:00 PM | | 451 | template10_help.php |
| 01/03/2008 | 01:00 PM | | 854 | template10_managePostcard.php |
| 01/03/2008 | 01:00 PM | | 1,439 | template10_pdf_data.php |
| 01/03/2008 | 01:00 PM | | 4,711 | template10_pdf_jumbo.php |
| 01/03/2008 | 01:00 PM | | 5,445 | template10_pdf_regular.php |
| 01/03/2008 | 01:00 PM | | 1,883 | template10_preview.php |
| 01/03/2008 | 01:00 PM | | 8,479 | template20.php |
| 01/03/2008 | 01:00 PM | | 2,826 | template20_database.php |
| 01/03/2008 | 01:00 PM | | 433 | template20_help.php |
| 01/03/2008 | 01:00 PM | | 836 | template20_managePostcard.php |
| 01/03/2008 | 01:00 PM | | 1,553 | template20_pdf_data.php |
| 01/03/2008 | 01:00 PM | | 5,117 | template20_pdf_jumbo.php |
| 01/03/2008 | 01:00 PM | | 5,698 | template20_pdf_regular.php |
| 01/03/2008 | 01:00 PM | | 2,011 | template20_preview.php |
| 01/03/2008 | 01:00 PM | | 5,832 | template23.php |
| 01/03/2008 | 01:00 PM | | 2,762 | template23_database.php |
| 01/03/2008 | 01:00 PM | | 433 | template23_help.php |
| 01/03/2008 | 01:00 PM | | 818 | template23_managePostcard.php |
| 01/03/2008 | 01:00 PM | | 783 | template23_pdf_data.php |
| 01/03/2008 | 01:00 PM | | 2,698 | template23_pdf_jumbo.php |
| 01/03/2008 | 01:00 PM | | 2,789 | template23_pdf_regular.php |
| 01/03/2008 | 01:00 PM | | 1,332 | template23_preview.php |

| | | |
|---|---|---|
| 24 File(s) | 70,109 | bytes |

Directory of E:\tools

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:00 PM | | 6,344 | addCard_delete.php |
| 01/03/2008 | 01:00 PM | | 5,280 | addCategory.php |
| 01/03/2008 | 01:00 PM | | 10,737 | addMailing.php |
| 01/03/2008 | 01:00 PM | | 6,588 | assignArtists.php |
| 01/03/2008 | 01:02 PM | <DIR> | | backup 10-19 |
| 01/03/2008 | 01:00 PM | | 490 | cardTemplatePopUp.php |
| 01/03/2008 | 01:00 PM | | 2,367 | cloneCampaign.php |
| 01/03/2008 | 01:00 PM | | 8,614 | confirmOrders.php |
| 01/03/2008 | 01:00 PM | | 2,829 | createCompany.php |
| 01/03/2008 | 01:00 PM | | 10,502 | createLabel.php |
| 01/03/2008 | 01:00 PM | | 9,962 | createLabel_new.php |
| 01/03/2008 | 01:00 PM | | 12,108 | cumulativeTotals.php |
| 01/03/2008 | 01:00 PM | | 80,747 | database.php |
| 01/03/2008 | 01:02 PM | <DIR> | | deleted 10-19 |
| 01/03/2008 | 01:01 PM | | 910 | displayOrderInformation.php |
| 01/03/2008 | 01:01 PM | | 4,967 | editUserType.php |
| 01/03/2008 | 01:01 PM | | 4,920 | generate_banner.php |
| 01/03/2008 | 01:01 PM | | 36 | index.php |
| 01/03/2008 | 01:01 PM | | 4,431 | listArtists_delete.php |
| 01/03/2008 | 01:01 PM | | 17,383 | listMailings.php |
| 01/03/2008 | 01:01 PM | | 15,224 | listMailings2.php |
| 01/03/2008 | 01:01 PM | | 3,655 | listManagement.php |
| 01/03/2008 | 01:01 PM | | 4,293 | listMessages.php |
| 01/03/2008 | 01:01 PM | | 2,468 | listProviderManagement.php |
| 01/03/2008 | 01:01 PM | | 2,203 | login.php |
| 01/03/2008 | 01:01 PM | | 22,800 | mailing.php |
| 01/03/2008 | 01:01 PM | | 13,695 | managePostcard.php |
| 01/03/2008 | 01:01 PM | | 14,048 | managePostcard2.php |
| 01/03/2008 | 01:01 PM | | 8,440 | manageUsers.php |
| 01/03/2008 | 01:01 PM | | 7,203 | menuOptions.php |
| 01/03/2008 | 01:01 PM | | 1,662 | messagePopUp.php |
| 01/03/2008 | 01:01 PM | | 7,401 | modifyGlobalValues.php |
| 01/03/2008 | 01:01 PM | | 16,246 | moneyDueArtist.php |
| 01/03/2008 | 01:01 PM | | 16,883 | moneyDueArtist_new.php |
| 01/03/2008 | 01:01 PM | | 15,940 | moneyDueArtist_old.php |
| 01/03/2008 | 01:01 PM | | 4,197 | newCompany.php |
| 01/03/2008 | 01:01 PM | | 5,984 | newLabel.php |
| 01/03/2008 | 01:02 PM | <DIR> | | old_version |
| 01/03/2008 | 01:01 PM | | 48,298 | php_init.inc |
| 01/03/2008 | 01:01 PM | | 2,369 | printForm.php |
| 01/03/2008 | 01:01 PM | | 331 | printSession.php |
| 01/03/2008 | 01:01 PM | | 359 | printVars.php |
| 01/03/2008 | 01:01 PM | | 4,821 | promo_form.php |
| 01/03/2008 | 01:01 PM | | 5,869 | promo_generator.php |
| 01/03/2008 | 01:01 PM | | 10,021 | rejectionMessage.php |
| 01/03/2008 | 01:01 PM | | 7,583 | repAccounting.php |
| 01/03/2008 | 01:01 PM | | 3,216 | resultsNavigation.inc |
| 01/03/2008 | 01:01 PM | | 1,912 | resultsNavigationFunctions.inc |
| 01/03/2008 | 01:01 PM | | 7,745 | reviewMailings_delete.php |
| 01/03/2008 | 01:01 PM | | 561 | session_retrieve.php |
| 01/03/2008 | 01:01 PM | | 547 | session_save.php |
| 01/03/2008 | 01:01 PM | | 4,532 | showBackGuidelines.php |
| 01/03/2008 | 01:01 PM | | 2,989 | showFrontGuidelines.php |
| 01/03/2008 | 01:01 PM | | 2,936 | shuffleMailings.php |
| 01/03/2008 | 01:01 PM | | 6,491 | step3.php |
| 01/03/2008 | 01:01 PM | | 20,607 | toolsMenu.php |
| 01/03/2008 | 01:01 PM | | 9,920 | trackOrders.php |
| 01/03/2008 | 01:01 PM | | 7,496 | trackUsers.php |
| 01/03/2008 | 01:01 PM | | 4,649 | usageMailings.php |
| 01/03/2008 | 01:01 PM | | 6,972 | usageStep1.php |
| 01/03/2008 | 01:01 PM | | 1,919 | writeMessage.php |
| 01/03/2008 | 01:01 PM | | 13,711 | x_confirmOrders.php |

| | | |
|---|---|---|
| 59 File(s) | 527,411 | bytes |

Directory of E:\tools\backup 10-19

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:00 PM | | 5,306 | To Do.txt |
| 01/03/2008 | 01:00 PM | | 7,031 | addAdmin.php |
| 01/03/2008 | 01:00 PM | | 7,032 | addArtist.php |
| 01/03/2008 | 01:00 PM | | 3,097 | addAssociation.php |
| 01/03/2008 | 01:00 PM | | 5,360 | addCampaign.php |
| 01/03/2008 | 01:00 PM | | 1,997 | addCampaign3.php |
| 01/03/2008 | 01:00 PM | | 4,072 | addCampaignCard.php |
| 01/03/2008 | 01:00 PM | | 4,702 | addCard.php |
| 01/03/2008 | 01:00 PM | | 4,607 | addCategory.php |
| 01/03/2008 | 01:00 PM | | 978 | addKeyword.php |
| 01/03/2008 | 01:00 PM | | 7,034 | addListProvider.php |
| 01/03/2008 | 01:00 PM | | 2,215 | addMailing.php |
| 01/03/2008 | 01:00 PM | | 1,704 | addProfession.php |
| 01/03/2008 | 01:00 PM | | 1,651 | addPurpose.php |
| 01/03/2008 | 01:00 PM | | 4,356 | addSingle.php |
| 01/03/2008 | 01:00 PM | | 1,606 | addType.php |
| 01/03/2008 | 01:00 PM | | 2,156 | admin.php |
| 01/03/2008 | 01:00 PM | | 1,259 | artist.php |
| 01/03/2008 | 01:00 PM | | 4,943 | campaign.php |
| 01/03/2008 | 01:00 PM | | 99 | checkAdmin.php |
| 01/03/2008 | 01:00 PM | | 193 | checkArtist.php |
| 01/03/2008 | 01:00 PM | | 2,781 | confirmOrders.php |
| 01/03/2008 | 01:00 PM | | 52,075 | database.php |
| 01/03/2008 | 01:00 PM | | 558 | db_functions.php |
| 01/03/2008 | 01:00 PM | | 6,507 | editCard.php |
| 01/03/2008 | 01:00 PM | | 2,749 | formChecker.php |
| 01/03/2008 | 01:00 PM | | 36 | index.php |
| 01/03/2008 | 01:00 PM | | 4,150 | innerHtml.php |
| 01/03/2008 | 01:00 PM | | 1,326 | listArtists.php |
| 01/03/2008 | 01:00 PM | | 3,478 | listCampaigns.php |
| 01/03/2008 | 01:00 PM | | 1,463 | listListProviders.php |
| 01/03/2008 | 01:00 PM | | 3,599 | listMailings.php |
| 01/03/2008 | 01:00 PM | | 3,078 | listManagement.php |
| 01/03/2008 | 01:00 PM | | 2,678 | listMessages.php |
| 01/03/2008 | 01:00 PM | | 1,291 | listTest.php |
| 01/03/2008 | 01:00 PM | | 1,385 | login.php |
| 01/03/2008 | 01:00 PM | | 72 | loginCheck.php |
| 01/03/2008 | 01:00 PM | | 182 | login_verification.php |
| 01/03/2008 | 01:00 PM | | 5,663 | mailing.php |
| 01/03/2008 | 01:00 PM | | 865 | menuOptions.php |
| 01/03/2008 | 01:00 PM | | 1,649 | message.php |
| 01/03/2008 | 01:00 PM | | 1,484 | modifyGlobalValues.php |
| 01/03/2008 | 01:00 PM | | 10,502 | moneyDueArtist.php |
| 01/03/2008 | 01:00 PM | | 5,568 | month_day_year.php |
| 01/03/2008 | 01:00 PM | | 2,664 | month_day_year2.php |
| 01/03/2008 | 01:00 PM | | 462 | popup.html |
| 01/03/2008 | 01:00 PM | | 331 | printSession.php |
| 01/03/2008 | 01:00 PM | | 3,678 | reviewMailings.php |
| 01/03/2008 | 01:00 PM | | 2,139 | showCampaign.php |
| 01/03/2008 | 01:00 PM | | 1,565 | states.php |
| 01/03/2008 | 01:00 PM | | 20,821 | step4.php |
| 01/03/2008 | 01:00 PM | | 120 | unknown.html |
| 01/03/2008 | 01:00 PM | | 3,245 | usageMailings.php |
| 01/03/2008 | 01:00 PM | | 9,797 | usageStep1.php |
| 01/03/2008 | 01:00 PM | | 494 | viewCampaign.php |
| 01/03/2008 | 01:00 PM | | 1,721 | writeMessage.php |
| 01/03/2008 | 01:00 PM | | 1,244 | zz_CHANGED_updateMediaPrices.php |

| | | |
|---|---|---|
| 57 File(s) | 232,818 | bytes |

Directory of E:\tools\deleted 10-19

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:01 PM | | 5,306 | To Do.txt |
| 01/03/2008 | 01:00 PM | | 3,097 | addAssociation.php |
| 01/03/2008 | 01:00 PM | | 5,360 | addCampaign.php |
| 01/03/2008 | 01:00 PM | | 1,997 | addCampaign3.php |
| 01/03/2008 | 01:00 PM | | 4,072 | addCampaignCard.php |
| 01/03/2008 | 01:00 PM | | 7,034 | addListProvider.php |
| 01/03/2008 | 01:00 PM | | 4,356 | addSingle.php |
| 01/03/2008 | 01:00 PM | | 4,943 | campaign.php |
| 01/03/2008 | 01:00 PM | | 52,075 | database.php |
| 01/03/2008 | 01:00 PM | | 2,749 | formChecker.php |
| 01/03/2008 | 01:00 PM | | 4,150 | innerHtml.php |
| 01/03/2008 | 01:00 PM | | 3,478 | listCampaigns.php |
| 01/03/2008 | 01:00 PM | | 1,463 | listListProviders.php |
| 01/03/2008 | 01:00 PM | | 1,291 | listTest.php |
| 01/03/2008 | 01:00 PM | | 462 | popup.html |
| 01/03/2008 | 01:00 PM | | 2,139 | showCampaign.php |
| 01/03/2008 | 01:00 PM | | 20,821 | step4.php |
| 01/03/2008 | 01:01 PM | | 120 | unknown.html |
| 01/03/2008 | 01:01 PM | | 494 | viewCampaign.php |

| | | |
|---|---|---|
| 19 File(s) | 125,407 | bytes |

Directory of E:\tools\old_version

| | | | | |
|---|---|---|---|---|
| 01/03/2008 | 01:02 PM | <DIR> | | . |
| 01/03/2008 | 01:02 PM | <DIR> | | .. |
| 01/03/2008 | 01:01 PM | | 5,438 | addAssociation2.php |
| 01/03/2008 | 01:01 PM | | 5,635 | addCampaign2.php |
| 01/03/2008 | 01:01 PM | | 1,997 | addCampaign3.php |
| 01/03/2008 | 01:01 PM | | 2,632 | addCard2.php |
| 01/03/2008 | 01:01 PM | | 1,704 | addProfession.php |
| 01/03/2008 | 01:01 PM | | 1,651 | addPurpose.php |
| 01/03/2008 | 01:01 PM | | 1,606 | addType.php |
| 01/03/2008 | 01:01 PM | | 3,148 | admin2.php |
| 01/03/2008 | 01:01 PM | | 867 | admin3.php |
| 01/03/2008 | 01:01 PM | | 3,344 | artist2.php |
| 01/03/2008 | 01:01 PM | | 649 | artist3.php |
| 01/03/2008 | 01:01 PM | | 1,353 | post.php |
| 01/03/2008 | 01:01 PM | | 126 | print_post.php |
| 01/03/2008 | 01:01 PM | | 2,170 | usageMailing.php |
| 01/03/2008 | 01:01 PM | | 9,530 | usageStep1_old.php |
| 01/03/2008 | 01:01 PM | | 1,244 | zz_CHANGED_updateMediaPrices.php |

| | | |
|---|---|---|
| 16 File(s) | 43,094 | bytes |
| Total Files Listed: | | |
| 448 File(s) | 3,179,354 | bytes |
| 24 Dir(s) | 0 | bytes free |

### SUMMARY

Some of the inventive principles of this patent disclosure relate to a method including: submitting marketing media to a media submission system; adapting the submitted media to a specification; and generating marketing output based on the submitted media and the specification. The method may further include any of the following: cataloging and/or tracking an originator of the submitted media; cataloging and/or tracking an application of the submitted media; cataloging and/or tracking utilization of the submitted media; managing design iteration of the submitted media; enabling a user to proof the marketing output in real-time; enabling a user to perform resolution scaling, cropping and/or file-type conversion of the submitted media; and/or integrating the media submission system with a marketing network. The marketing may network operate across a variety of media types.

Some additional inventive principles of this patent application relate to a method including: operating an online marketing resource system; and facilitating collaboration of different types of users of the marketing resource system. The different types of users may include: designers, media vendors, content controllers, and/or end-users. Marketing media may be processed for output based on account types and rules-based interaction between the account types. Processing of marketing media may include: constructing, submitting, reviewing, storing, monitoring and/or distributing the marketing media.

Some additional inventive principles of this patent application relate to a method including: procuring marketing media through a media submission system; and consigning the marketing media through peer-to-peer interaction on the system. The method may further include managing online business relationships between different types of users of the system. Additionally, the method may include assigning different account types to the different types of users. Permissions-based controls may be used to manage the business relationships. The different types of users may include: content developers, content controllers, and/or content users. The method may further include statistically monitoring and/or analyzing demand, application and/or response of the marketing media. Additionally, the method may include targeting the marketing media in response to the monitoring and/or analysis. As a further feature, the method may include: tracking performance through the system; and determining compensation in response to the tracked performance.

Some additional inventive principles of this patent application relate to a method including: deploying marketing media through an online marketing resource system; collecting and storing empirical marketing data that relates to specific media content deployed through the system; and correlating the specific media content to target demographics. The method may further include any of the following: re-deploying marketing media through the system in response to the correlation; creating a stored procedure in response to the correlation between the specific media content and target demographics; matching media content to target demographics as a stored procedure; and/or creating a baseline for a user in response to the correlation. In some embodiments, the empirical marketing data may be obtained through real deployment and/or provided by marketing professionals.

Some additional inventive principles of this patent application relate to a method including: operating an online marketing media creation system; and creating the marketing media through a combination of rules-based input sources. The method may further include any of the following: using coordinate-style layout positioning and/or layering to assemble media layouts; and/or integrating the media creation with a marketing network. In some embodiments: the media creation integrates with the marketing network by allowing different types of users to set permissions and/or rules-based controls; the permissions and/or rules-based controls are applied to layout elements; the layout elements may be uploaded, inserted and/or written by an end user; and/or the layout elements may be mandated for inclusion by a content designer and/or a content controller.

### BRIEF DESCRIPTION OF THE DRAWINGS

FIGS. 1-11 illustrate an embodiment of a loading system according to the inventive principles of this patent disclosure.

FIG. 12 illustrates an embodiment of a screen for a template generator according to the inventive principles of this patent disclosure.

FIG. 13 illustrates an embodiment of a screen for a tool for designers to access site statistics according to the inventive principles of this patent disclosure.

FIG. 14 illustrates an embodiment of a screen for a tool for designers to manage a campaign according to the inventive principles of this patent disclosure.

### DETAILED DESCRIPTION

### Overview

This patent disclosure encompasses numerous inventive principles relating to marketing and/or advertising systems. These inventive principles are described in the context of various embodiments, including some commercial embodiments such as those implemented in the AdSwift.com website. However, the inventive principles are not limited to these specific implementation details. Moreover, the inventive principles have independent utility, but may also be combined to provide synergistic results.

Some of the inventive principles of this patent disclosure relate to media loaders. In some embodiments, a media submission system automatically adapts media uploads to various preset specifications, catalogs and tracks the originator, the media application, and overall utilization, and manages design iteration. Such a system may include a real-time PDF-based proofing tool, resolution scaling and cropping functions, and file-type conversion. The media submission system may integrate with the other areas of an online peer-to-peer marketing network and work across a variety of digital media types. An embodiment of such a system may simplify and homogenize media uploads for consistency within the system and to distribution sources.

Some of the inventive principles of this patent disclosure relate to resource hubs. In some embodiments, a marketing media resource system facilitates the roles of marketing designers, media vendors, content controllers and end-users in a managed online collaborative peer-to-peer environment. Marketing media is constructed, submitted, reviewed, stored, monitored and distributed for output based on series of account types and rules-based interaction between those account types. Such a system may have a more competitive variety of targeted marketing, more immediate availability, and lower cost. It may be easier to use, and with greatly reduced deployment time.

Some of the inventive principles of this patent disclosure relate to designer tools. In some embodiments, a method of marketing procurement and consignment leverages peer-to-peer internet architecture for the media design industry. Such a system and method may use a series of permissions-based controls between various account types to manage and facilitate online business relationships between content developers, content controllers and content users. These tools may include statistical monitoring and analysis of the media demand, application, and response. Access to such information may increase the developers' capability to achieve higher performance targeting. Performance may then be tracked throughout the system as a basis for monetary compensation.

Some of the inventive principles of this patent disclosure relate to performance matching. In some embodiments, a method includes collecting and storing empirical marketing data as it directly relates to specific media content. Such a method may utilizes demographic response information gathered from real deployment, or provided by marketing professionals, and create a correlation which is then presented for fast and easy repetition. By matching media content to target demographics as a stored procedure, the system may give the novice user a baseline for marketing that ultimately yields higher response performance more immediately and produces less waste.

Some of the inventive principles of this patent disclosure relate to template generators. In some embodiments, a template system may generate real-time digital media from a combination of rules-based input sources. The template system may use a coordinate style layout positioning and layering to assemble media layouts in real-time from multiple input sources. The template system may integrate with the other areas of an online peer-to-peer marketing network by allowing different account types to set permissions and rules-based control of the various layout elements. These elements can be uploaded and inserted, or written, by an end-user or they can be mandated for inclusion by the content designer and content controllers. The template system may be flexible enough to accommodate a variety of layouts and applications in both open trade and corporate compliance environments.

### Loader

Some of the inventive principles of this patent disclosure relate to loaders for web-enabled advertising systems. Details of a complete commercial embodiment known as SWIFT LOADER™ in the ADSWIFT™ marketing and advertising system are provided in the appendix of documents below. However, an overview of a 5-step ordering process is provided here for convenience.

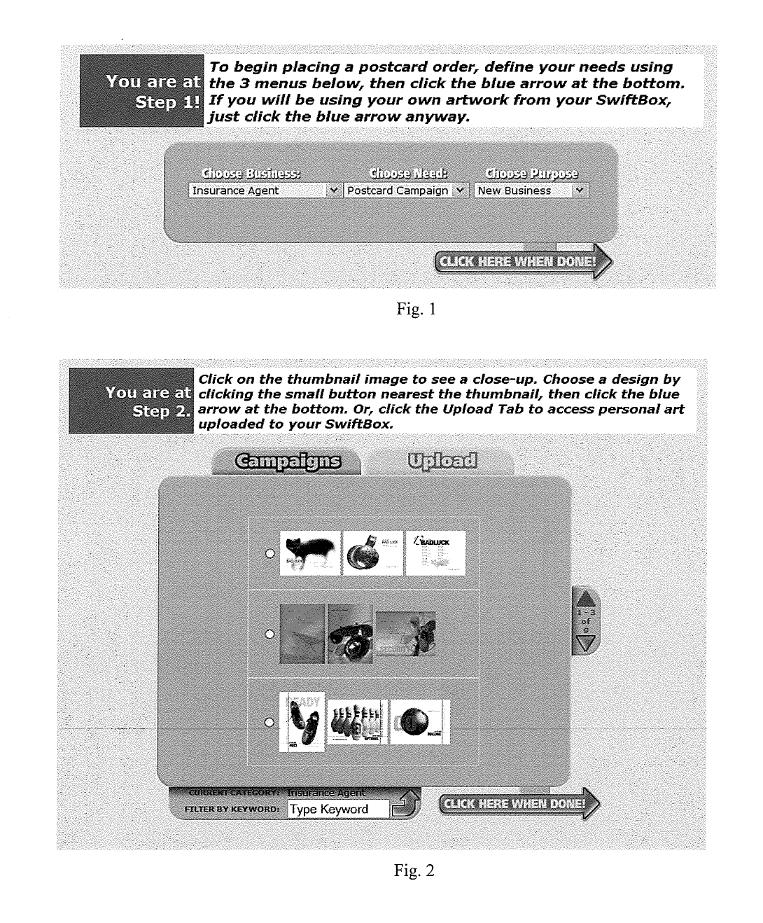

The first step (FIG. 1) is to define the advertising program such as a single postcard mailing, or a campaign which includes multiple cards designed to work in succession, or “dripping” which is the same post card sent to successive lists. Other media types such as video may be used. With a campaign, the user can setup a multi-release program extending up to suitable length of time, for example 20 months, and auto-launch it so that it sends a different postcard to the same customers every month. Added features may include the construction of a preset “macro” button which enforces the selections made throughout the 5-steps as per corporate dictate.

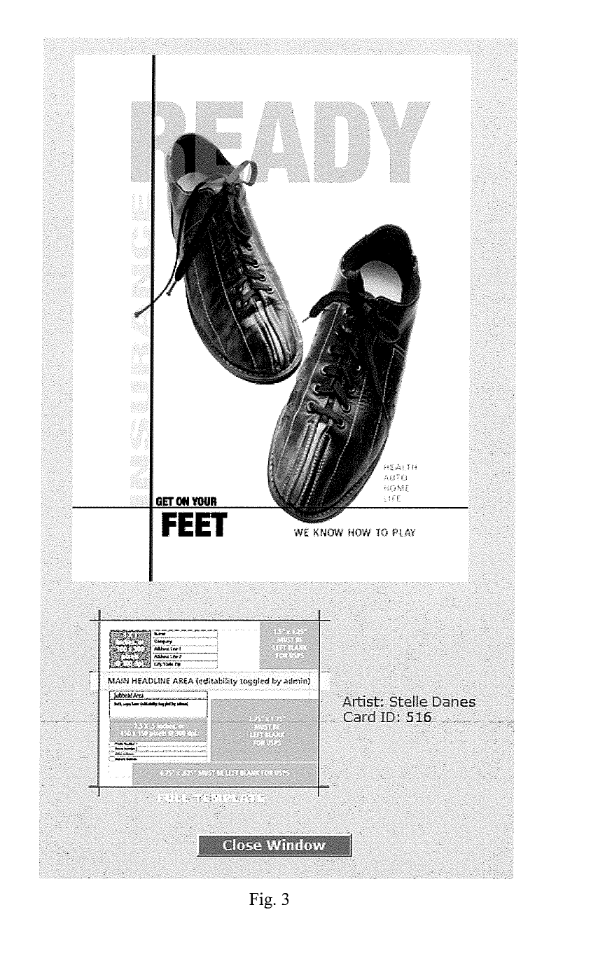

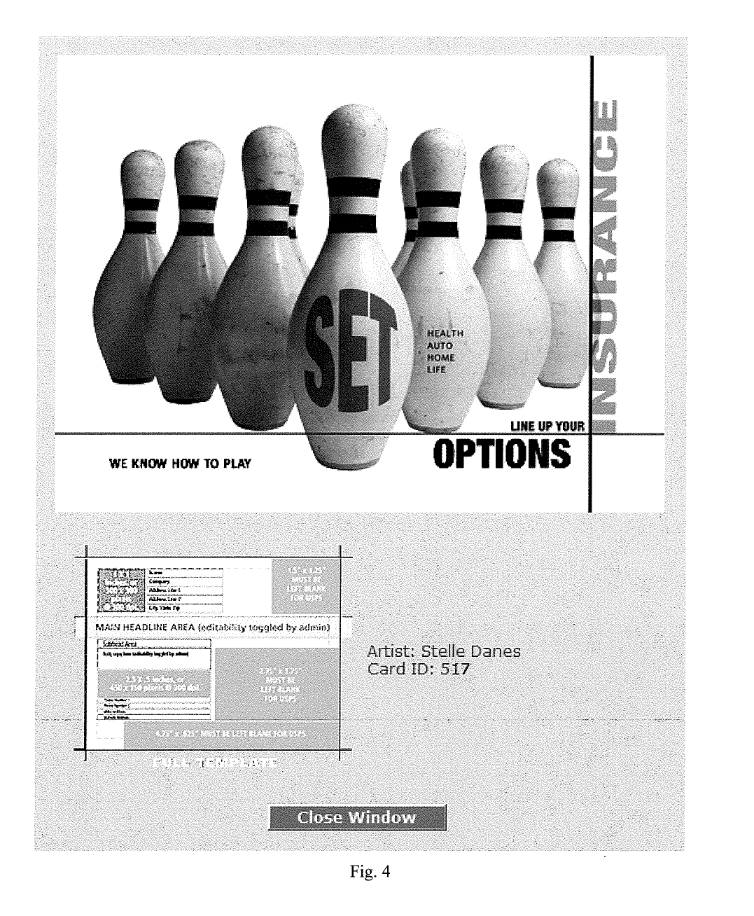

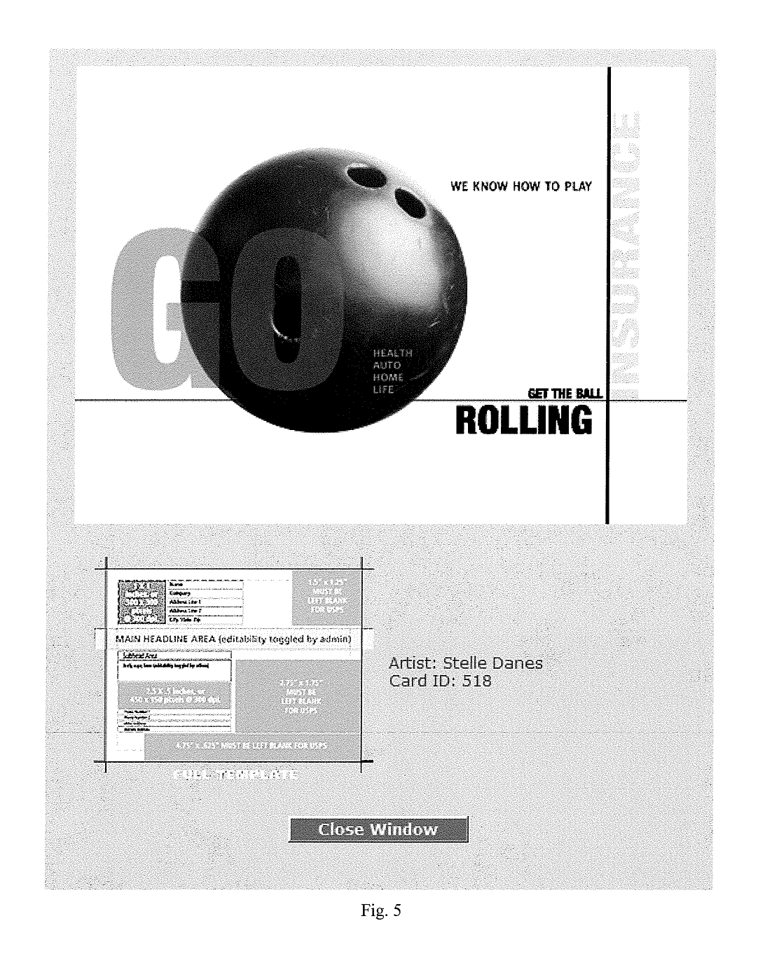

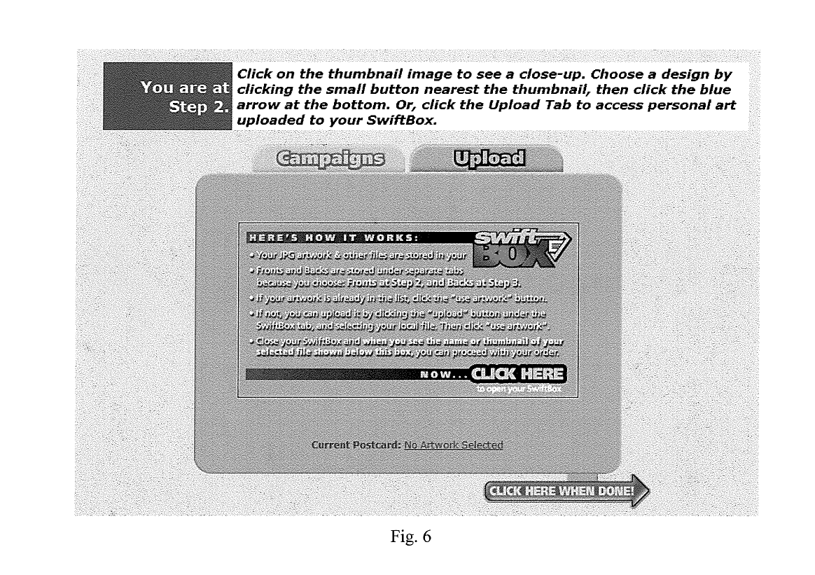

As an example, assume an insurance agent selects a postcard campaign. At step 2 (FIG. 2), the agent selects a three postcard bowling themed campaign with three cards: “Ready, get on your feet, we know how to play. Health. Auto. Home. Life. Insurance.” (FIG. 3); “You've got your shoes, there's the pants, set, line up your options.” (FIG. 4); and then the last card hits them which is, “Go, get the ball rolling. Call us.” (FIG. 5). These are the three different postcards that will go out over time. The user can optionally click the upload button (FIG. 6) to retrieve artwork and other files stored in their SWIFT BOX™ storage area for inclusion or replacement.

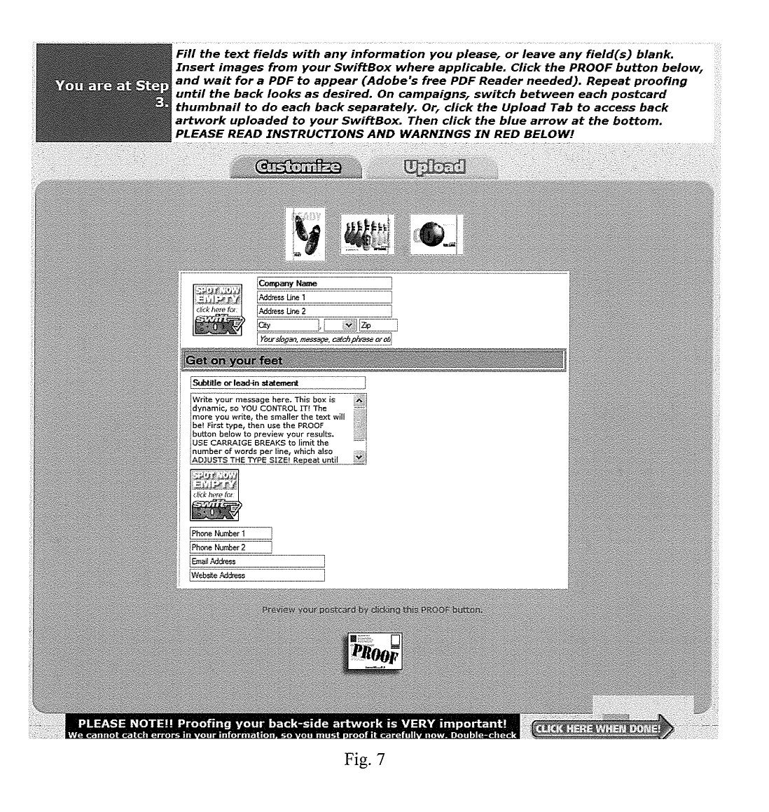

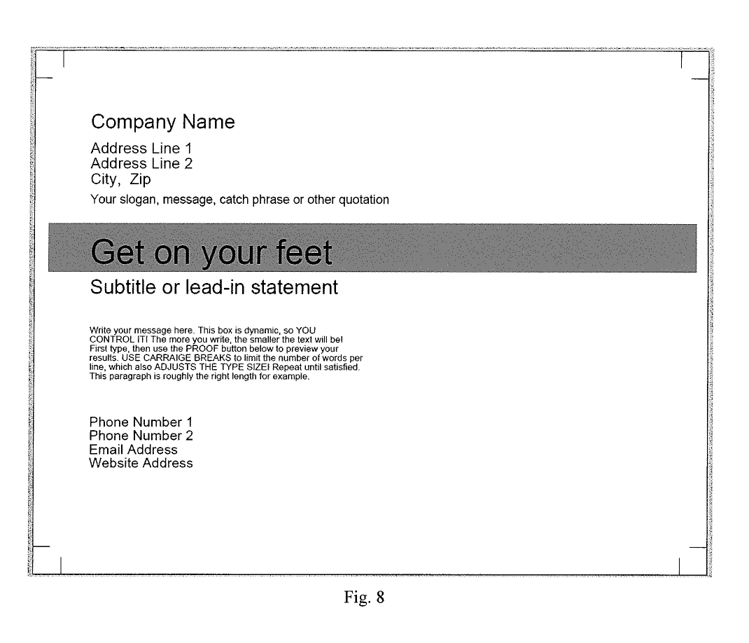

At step 3 (FIG. 7), a template enables the user to insert, e.g., a picture of the agent, and the agent's logo or any other graphics on the backside of the card. This example illustrates a full template meaning the end user controls everything. Other templates have varying degrees of control and rules. Additional sections of the template enable the user to type in any message they want, e.g., “Get on your Feet Now”. This dynamically scales the text depending on how much the user types. Clicking the proof button causes the system to automatically take the input graphic files and text from both the end-user and the designer/controller, and generate a real-time preview of the layout (FIG. 8) ready to be distributed to printing vendors or other advertising production or display systems. When the end-user uses a template in the creation of a custom back for their postcard order, they are also able to save that specific layout and content PDF to their SwiftBox, where it can be retrieved for later use.

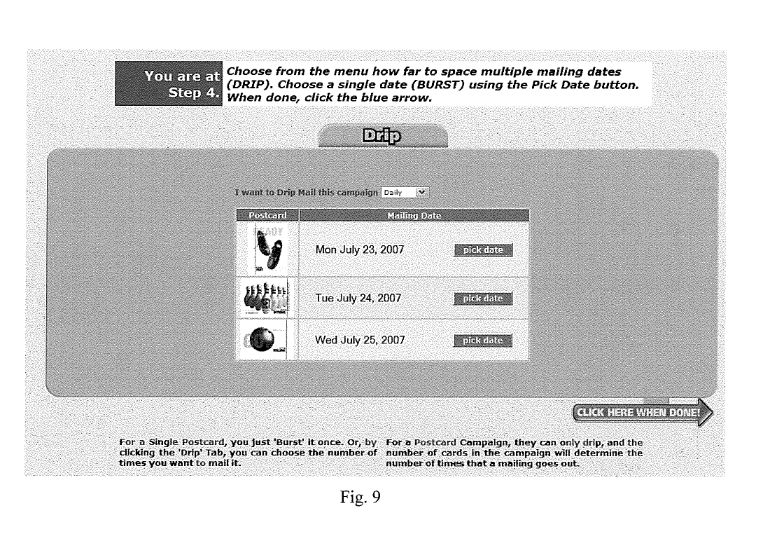

At step 4 (FIG. 9), the user can specify the dates on which the marketing will be mailed, shipped, or aired. Further development here may include more precise scheduling tools for digital display deployment and other air-time specific channels.

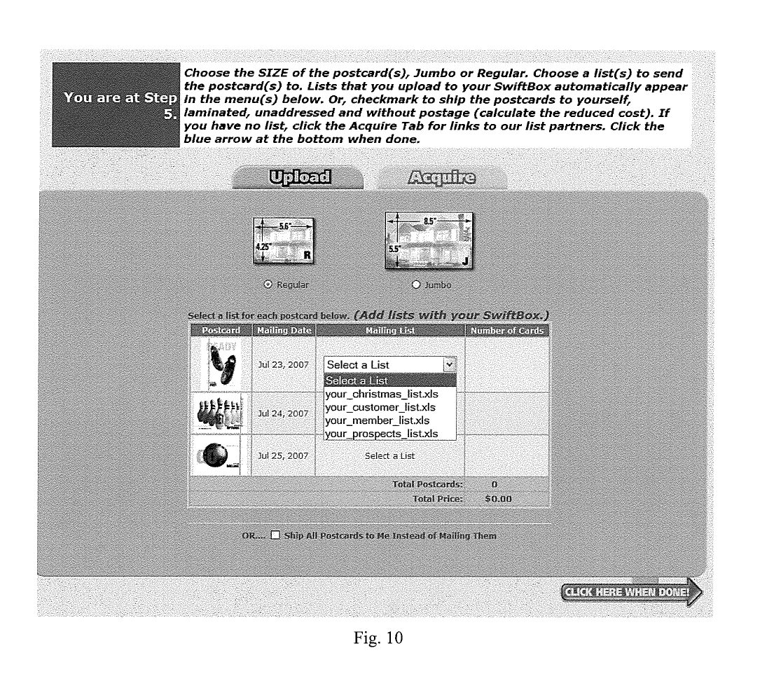

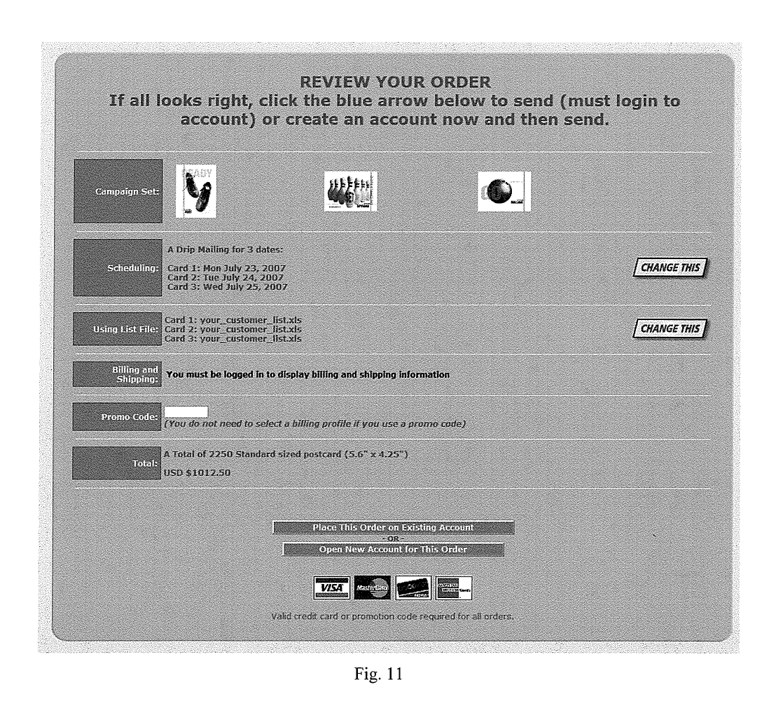

At step 5 (FIG. 10), the user links this succession of three postcards to a customer list, which may be uploaded into the user's SwiftBox and then shows up here. Additional features may include the parsing of an uploaded list into its individual records, so that they can be managed and new lists generated from selected records. Or, the user might opt to purchase list information from data providing vendors, based on demographic data. The user designates media size here which also tabulates cost. When finished with step 5, a review feature (FIG. 11) allows the user to confirm the details of the order. In an alternative embodiment, the data ordering form (or step 5) may prepopulate directly the performance matched demographic choices to further assist the user in sending a their chosen message to a more narrow and empirically proven responsive target audience. In this example, the campaign might be targeted to people who need insurance and enjoy bowling.

### Resource Hubs and Narrowcasting

Some of the inventive principles relate to connecting multiple marketing resources that go into mailing or other media based marketing and advertising, examples of those resources being: corporations, small businesses and independents who are the customers; developers of creative media content, corporate compliance officers, list companies or market research firms who provide the demographics—the lists of the people to distribute mailings or other media to; fulfillment operations for postcards and other media such as direct/dynamic digital signage (DDS), e.g., flat panels that appear in bar rooms, walls, bank walls, etc. The principles used for implementations that distribute .pdf files to printers (e.g., for postcards) are readily adaptable to implementations that distribute shockwave-flash, and other digital motion-media to flat panels and other electronic marketing channels.

According to the inventive principles, a company may position its system as a media hub having accounts that graphic designers create, accounts for people (small businesses, corporate users) who are looking for marketing resources and these accounts tie into list acquisition and fulfillment. This may be accomplished through postcards, business cards, as well as other products and media that are either physically produced or displayed by use of airtime.

A system may be structured so that the administrators of the large corporations have tools so that they can control who gets to communicate with whom and about what, what designers are associated with what accounts. The designers can directly submit into these accounts, using review types of tools with two-way feedback. So it completely manages the iterative design process, including corporate compliance, legal compliance and corporate “voice”.

Some additional features are as follows: an approve and review system in which a designer can submit artwork to a company, the company can look at it and either respond with a, “No, we need changes” or respond by saying, “Click Yes, we want to use it.” Once a postcard has been submitted by a designer and is in use, performance-based compensation tracking may optionally be used to account for royalties. A designer can upload a design to a company and, if the agreement is made between that designer and the company, the designer receives a certain percentage based upon usage of that material. The designer can track all of that in their tools as can the company. So it shows them how many cards have been ordered, when they've been ordered, and multiplies that by their percentage to show how much money they've earned in a given period.

In some embodiments, a system may be implemented as a hub for content. For example, a small business such as a local hair salon which can't afford an ad agency, and doesn't have marketing resources, can go to a website for the system, pull up a category for hair salons and see all kinds of unique ideas that have been uploaded generically by designers across the country. After selecting one of those ideas that is appropriate for their hair salon, they can use a template engine or generator to customize a postcard with their own identity and message. The template generator creates the back of the postcard. There are fields they can fill out on screen, and they can also upload little images, e.g., a realtor can upload an image of a house, or a map to their location or their logo. They can upload parts into it. If it is under corporate control, then the corporation can put required graphics and text be included as well. It provides a combination of allowing for a master controlling entity to decide what can be said and allowing certain flexibility to the end user to customize it for themselves as well. In this embodiment, a hair products company for example, can then provide brand specific marketing to the independent hair salons, allowing the salon to customize select parts of the layout for themselves while maintaining corporate voice and compliance on other parts. The system goes so far as to even allow the company to provide a pre-created selection of compliant components that the end-user can choose from and optionally insert, or mix with their own uploaded components.

A system according to the inventive principles may enable designers to upload a wide variety of materials to the site, knowing that they can continue to earn long-range residual income. Business users can come to the site, knowing that they can constantly find new and fresh material that they can customize with their own identity. For brand specific content as provided by companies to their sales forces, the system allows for specification of “premium-pricing” so that a company may offset licensing and development costs for the brand content.

As an example to illustrate the benefits to a designer, a designer might typically charge $150-200 to design a postcard if they were just asked to do it on fee. With a system according to the inventive principles, if the designer uploads a postcard into the system and it never gets used, they don't make any money. On the other hand, if the design is adopted and used by a business, the designer could be making $200/mo or more for as long as it is used. In some embodiments, the designer-upload feature and royalties may be tied to particular companies and/or at particular pricing.

In some implementations, every designer that signs up for a design account gets a menu that says what companies they can submit artwork to. The menu can list every business user for the system. One potential benefit of signing up designers for the system is that each new designer may bring with them all of their clients as potential business-side users of the system. However, a designer may be reluctant to bring their clients to the system if the designer's client's end up on the menu that every other designer can see. Therefore, some other implementations may create “permissions” for a business user. For example, a business user can go to a Designer Contact page, find a designer, contact them by email or website. If they decide they like that particular designer's style and think that designer will be good to work with, they can go into their tools, find that designer, and give that designer permission to submit designs to their own account specifically.

A system may be implemented as a “Contact Board” or system project broker to put together designers with companies as a flexible, centralized resource that enables the system operator to develop a niche market from both retail and corporate perspectives. At the retail level, businesses that need to get some marketing done, for example, some direct mail, but have no idea where to begin can go to the system website, and with a few clicks, obtain everything they need in turn-key system that is ready to go. At the corporate level, if a local agent of a national investment broker needs to do some marketing, and the national broker has a contract set up for the system, the local agent has access to content that is compliant and legally approved. So, the local agent can add some customized content with little effort, and the material is then ready to send out. The national broker controls certain content at the corporate level, while the local agent controls other, personalized content. Thus, in some implementations, the retail version is a kind of open forum of brand-it-yourself, while in a corporate version, the corporation is using the same tools, but controlling their own content. An additional feature includes a blog-like function to facilitate the communication of “best practices” and other peer-to-peer marketing strategy sharing. This further increases the dissemination of successful ideas throughout a company.

Using the inventive principles, a system operator can build long-term equitable value and make itself indispensable to customers, especially as the amount of content in the system increases. The system becomes an exchange forum for design and marketing. This is especially important as content becomes the currency of the business world. As color printers continue getting better and less expensive, the content becomes the focus of value. List companies are always going to be accessing their databases and so on, but the inventive principles enable the system operator to control the actual content. Once companies upload their corporate-approved content, which sometimes takes weeks or months to get it through their legal departments, and then that corporate-approved content is in the system, it's locked in the system. In other words, if somebody wants to use that material that these companies have invested their time and energy in, put their collective experience into this marketing, they have to go the system to get to it if they are using the system for that content. When used in conjunction with performance based matching data, a valuable history of marketing knowledge is stored and made both immediately and ubiquitously available to newcomers in the organization. Thus, a long-term equitable value is built: the more content the system has, the more indispensable it becomes.

An advantage for business-side users of the system is that it leverages their successful sales techniques that have been developed at the national level, and encapsulate these successful sales techniques and make them available on a turn-key basis to every new agent.

### Designer Contact Board and Selection Tools

Some of the inventive principles of this patent disclosure relate to resources for designers and business-side users. These resources include tools that are shared between the administrative participants in this site, from various corporate private labels and the designers themselves. The tools enable access to the design community as a resource for customers' target marketing. They enable the creation of peer-to-peer business relationships between the designers that sign up for this system and the business accounts that are looking for design resources. Within the context of a web site, design accounts can directly interact with the business accounts so that they can submit through the review tools such as the pending/approved/etc status bars. It manages the iterations of design back and forth between the designer and the business account. When a design is reached that is satisfactory to the business customer, then it becomes available to the entire distribution network of that customer.

One of these tools lists all of the artists in one column, all of the companies in another column. A master administrator of the system can decide who gets to work with who. On the secondary Administrative level, or any administrator controlling a corporate account, the user can see all the artists in the system through the same tool but they can only see their own private label or any groups within their private label that they've created. The administrator can find an artist in the system and request that the artist work with a particular division. Thus, a Review and Approval system is setup between those two to work together.

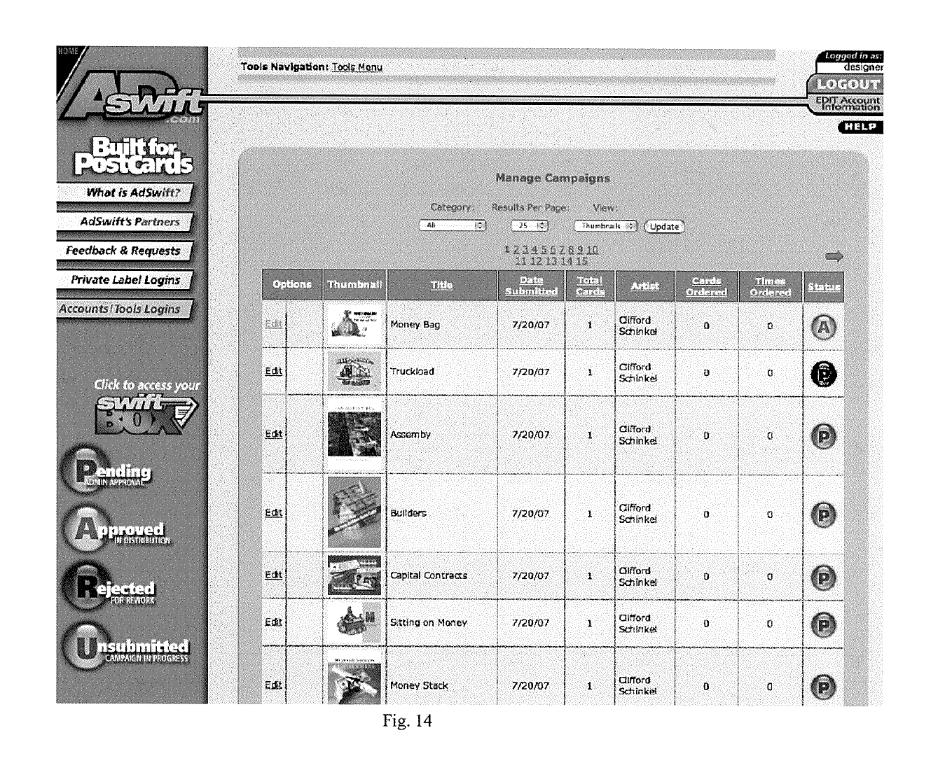

A Designer's Account is structured with a menu that allows the artist to submit artwork (see, e.g., FIG. 14). For example, a designer can use a Create Campaign tool to create a test campaign. The designer can select one of the templates to assign to the campaign, e.g., a campaign for a first seminar put on by a company, and then select which company or companies to submit the artwork to. The designers can be given different levels of privileges, for example, companies that have authorized the designer and given them permission to work with them. Thus, it enables a well-managed environment for the creation, review iteration, and distribution of design content.

On the business-user's side, an administrator can log in and review submissions from various designers. Any approved submissions that are acceptable can be added to the administrator's account for use, automatically, by everybody in the administrator's account. The designer can log into the designer's account and see which submissions have been approved, which are rejected. A rejected submission can be deleted by the designer. However, once it's been approved, the designer cannot delete it. Because if its been approved in the system, that means somebody else is using it and the designer cannot take it away. Thus, a submission cannot be changed unless the Administrator allows it to be changed.

Another feature enables business customers to contact designers to talk to them and exchange comments. A Designer Contact Board includes a list of every designer in the system who opts in and provides contact information—email, a website, phone number, general state of origin, city, and/or a comment field where a designer can give a brief description their style and their services. The business users can use the Designer Contact Board to look for designers that specialize in a particular type of business. The business's Administrator can than find the designer in the Assign tool and give the designer permission to work with the business.

These features enable the system operator to market the system to the design community. An advantage is that, with designers come all the clients they design for as likely business-side users of the system. This also creates a synergy because existing business-side users have a demand for design services. This contributes to the development of the system as a hub for networking marketing resources.

If a designer can see every company in the system, the list may become too long, and get confusing. Also, a designer will be reluctant to refer their clients to the site if every other designer can submit to those clients. Also, if a private label administrator opens a design account to submit to themselves, it may be they may be able to see all the other companies in their menu too. Therefore, another feature limits which companies a design account can access to submit to. This is somewhat similar to the way a group administrator can only see his own group to submit to. This also becomes a selling feature where the system allow the administrators to see a list of the designers and can choose (on/off) which ones they want to work with. The administrator can contact designers by email on the board, then “grant them access” to their account. For designers who refer their clients to open an account, the designer can tell the client to select that particular designer. These two enhancements can enhance the system's position as a hub. The system offers free exposure for the designer, and a stream of potential clients. For business users, the system offers easy access to designers, and selectively “connects” their accounts for business.

Some possible implementation details are as follows: 1) a tool in administrative accounts with an on/off switch next to the designer list that sets them in the designer's submit menu. 2) When a private label administrator (PL admin) opens a design account, it automatically makes the originating PL appear in the new account's menu. 3) Any design account that hasn't been granted access to a company yet, by default sees the overall system to submit to. 4) Because many PL admins actually do upload themselves, a “Create Campaign” button may be included in their tools, exactly like the one in group admin tools.

Some additional features relate to feedback forms. A business can make a request to the designer's message board. It comes in as a “Design Request.” In some implementations, every designer gets the request. In other implementations, only certain designers get the request. Any designer getting the request can respond with a submission. It is a way to find opportunities.

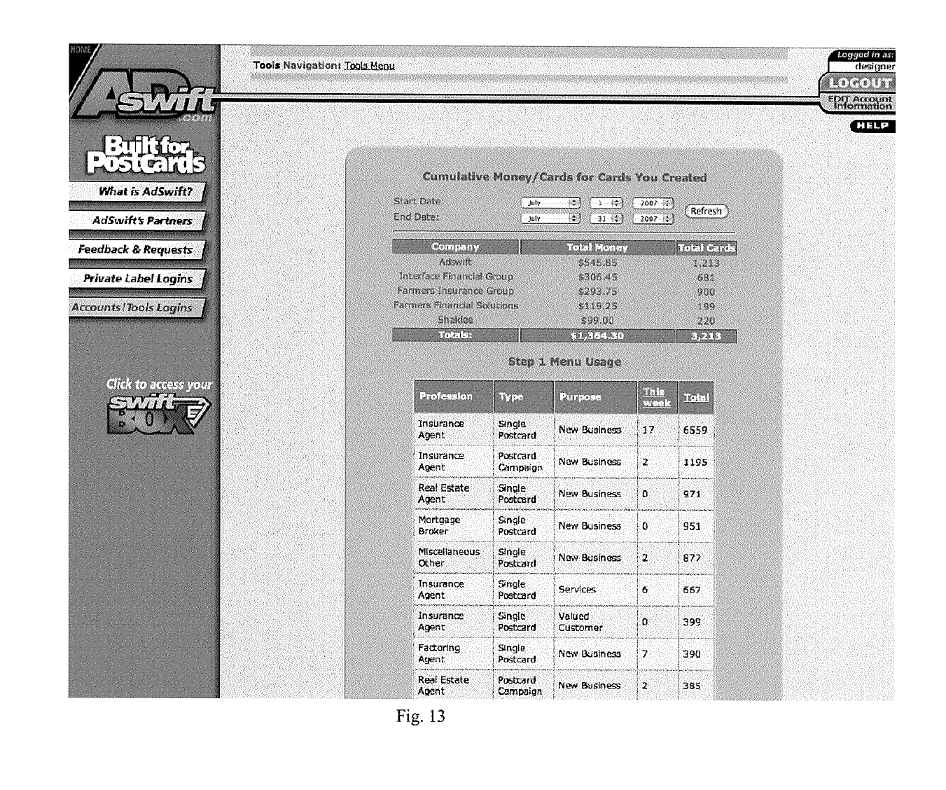

The designer tools also provide ways to gauge opportunity through site statistics to help the designer decide if the opportunity is worth pursuing. They enable a designer to track what happens on the three front menus of the website so as to illuminate what the end users are looking for (see, e.g., FIG. 13). For example, the statistics might show that there have been 26 this week, but a total this year of 6,381 insurance agents that came in looking for a single postcard for new business. Thus, a designer can determine that there is a high demand for insurance agencies and see there have been very few orders for it. High demand and few orders means they're not finding what they want. This is an opportunity for the designer to develop a new stream of revenue—to achieve residuals. Or, the statistics might tell the designer that two people came in looking for designs for a factoring agent, but all those orders have been filled. That means the users are finding what they want, so the designer probably doesn't want to develop in that category. The statistics are a tool for designers to actually analyze the demand and marketplace.

### List-to-Content Performance Matching

Some of the inventive principles relate to identifying and/or leveraging relationships between advertising content and list demographics.

Step 5 (FIG. 10) illustrates two tabs, one says Upload, and the other, Acquire. The menu under the Aquire tab displays an ordering form . . . checkboxes and the like, . . . for the most common demographic, geographic and psychographic list filtering criteria. Examples would be male vs. female, rent vs. own, income bracket, zip code and radius, etc. The selections on this form would get sent to a provider to pull against. This can be implemented so that, with tools in the admin section, a company can “preset” the optimum list criteria for each postcard they upload to the system. This is similar to what list companies define as a “macro” . . . but the difference is that this sets a unique macro for each postcard. By allowing the company to “pre-match” desired list demographics with the exact content they're sending . . . the agent who is ordering does not have to think about these details, and will have the company's best baseline recommendation for target audience. They also have the option to modify the presets for their own specific circumstances.

The form may only be “pre-populated” based on which postcard the agent selects. The company can always modify those settings if they choose. But least the company can optimize the potential for response, (i.e.; define who the postcard is aimed at) . . . and communicate that to the agent, automatically.

In a system having premium pricing programmed, and can create “packages”, it is readily adaptable to automatically charge a base media price if they use their own list, or charge the higher combined price if they submit the form with their order, thus buying the list with the order. Thus, the system may make the prospecting list match the postcard content in advance, so the whole process is even simpler and more turn-key . . . and is more effective while requiring less thought and effort from the customer.

### Template Generator

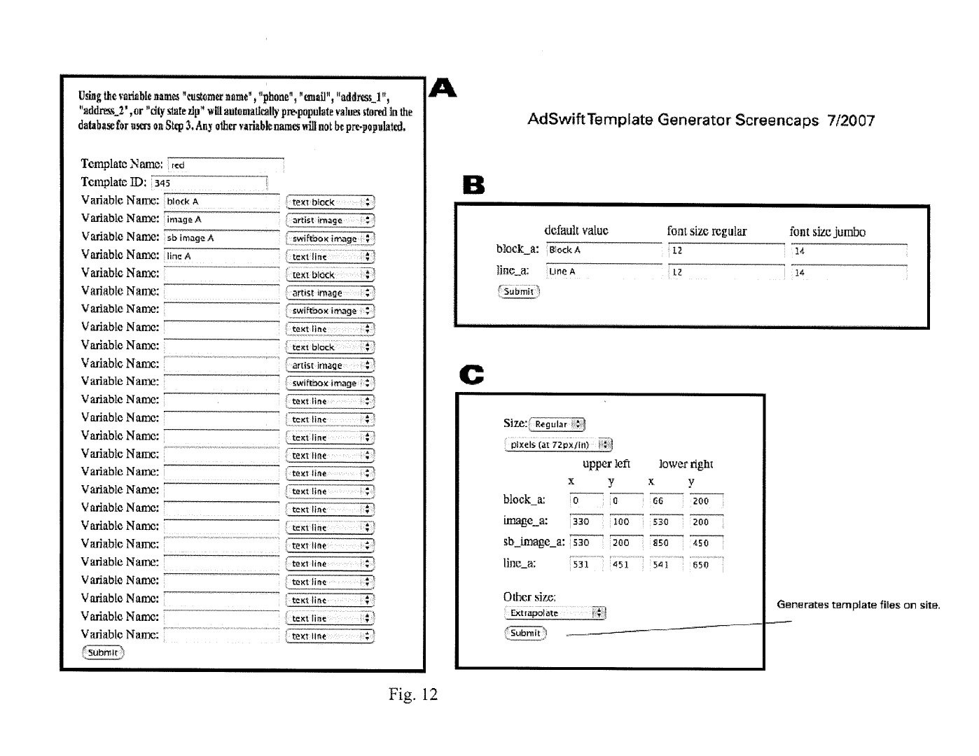

Some additional inventive principles relate to template generators that enable users to design their own templates. For example, a customer can designate a logo or logo spot at the top of the postcard design and specify that it is for an image from the end-user's personal SwiftBox storage area. As another example, the customer can designate a horizontal bar for text or images and assign it a name. As shown in FIG. 12, the template generator enables the user to go through a list that inserts elements and defines variable names for each one. In some embodiments, Variable Name may be exported from an Excel spreadsheet. Thus the system provides a natural path to a very, powerful dynamic data engine where each and every postcard that comes out of it can have different text, e.g., “Hi, Bob. Thank you for buying your Cadillac” and here's a picture of your Cadillac. The next one could be “Hi, Jim, thanks for buying your Volvo” and a picture of your Volvo.

Another example of a user definable element for the template generator is an account information element, which may be one of a number of variables that are pre-defined. Email, phone number, address, name and other options automatically pre-populate from their account information so the user does not have to retype that every time.

Locations of the various elements can be defined in coordinates starting at 0,0 in the upper left and, for example, at 217, 112 in the lower right which can be typed in. That is, Upper Left, Lower Right for X and Y on each element. Thus, the layout of graphics, text, bars, etc., is easy to designate accurately. Overlapping coordinates are layered using technology inherent to PDFs.

Not only do users have the ability to build a template from scratch, but the system also has an edit capability that enables the user to take any template, push it back into the number coordinates, and edit the number coordinates and feed it out as a new Template. Thus, the user doesn't have to start from scratch. If one of the existing templates is close, the user can dump it into the template generator, parse it back out into all the numerical coordinates that originally created it. The user can then adjust those coordinates and save it as a “new” Template. So, if a user decided they liked a pre-existing design, but wanted to add a little graphic somewhere, they can do it more easily than starting over.

The template generator may create both the regular and the jumbo size post cards simultaneously so the user doesn't have to do two different pieces of work. The variation and point size can be decided separately between regular and jumbo, or they can be scaled and/or shifted in proportion. For example, the user can start from the regular size to define the coordinates and then have the generator extrapolate out to the Jumbo size. So, it has a certain percentage that it multiplies up and everything just scales proportionately. Or, the user can do a straight copy. In other words, if it looks a certain size on the back on the regular, it will look exactly the same on the Jumbo. Or it can work in reverse by defining the Jumbo and extrapolating down to the Regular. Coordinates can be pixels, dpi, etc.

### Rep Accounts

Representative accounts contribute to the volume of sales through a system according to the inventive principles. A representative may be given support materials such as a Sales Kit, the company brochure, and/or some corporate identification files to print the system operator's logo on the representative's letterhead, and/or the interactive presentation, in Flash, for them to make presentations with.

Representatives have several features available to them, one of them is a Banner generator which gives the them an HTML HREF string that encapsulates their partner ID, so they can connect this string to any button on any site. If anybody clicks through it it's automatically tracked as their business. They have the ability to see every user that did click through their site. They can see the date and everything else relating to orders but they cannot access the list. Similar features apply to credit card numbers for Administrators. They can see the last four digits, but not the whole number, for the purpose for being able to communicate. Other implementations may support independent sales representation including rep ID detection for swapping of front page graphics. In one example, when a person clicks through a link on Bob's site, the graphic on the AdSwift site automatically change to say “Welcome to Bob's customer”. Another embodiment of the sales role allows that any sales rep can control and manage their own customer's media accounts through a well-defined application of all the aforementioned process and systems. In other words, an embodiment of a system according to the inventive principles may be well suited for franchising.

### Proofing Refinements

In some embodiments, under Step 3 for example, an additional feature enables a user to proof as either a Regular or as a Jumbo. This feature may coordinate with a template generator because it could make a difference on whether it was shown to be in the upper corner or whether it was extrapolated larger, etc. The user can decide which way they would like to proof it, and once it has been proofed, the user can save to their storage area (for example, the SwiftBox™ storage area) and the system will drop the .pdf into their storage area so that they do not have to use the template next time. Then, the next time the customer uses the system to customize, the customer may simply use the Upload Tab and get it from their storage area.

### Source Code

Though not necessary to enable a person of ordinary skill in the art to make and use the inventive concepts, the files and directory structure included in the computer program listing appendix provide an example implementation of a system according to the inventive concepts.

The inventive principles of this patent disclosure have been described above with reference to some specific example embodiments, but these embodiments can be modified in arrangement and detail without departing from the inventive concepts. For example, the embodiments described in the context of a postcard marketing system may also be applied to a system using any type of media, for example, video. Such changes and modifications are considered to fall within the scope of the following claims.

1. A method comprising:
submitting marketing media to a media submission system;
adapting the submitted media to a specification; and
generating marketing output based on the submitted media and the specification.

2. The method of claim 1 further comprising cataloging and/or tracking an originator of the submitted media.

3. The method of claim 1 further comprising cataloging and/or tracking an application of the submitted media.

4. The method of claim 1 further comprising cataloging and/or tracking utilization of the submitted media.

5. The method of claim 1 further comprising managing design iteration of the submitted media.

6. The method of claim 1 further comprising enabling a user to proof the marketing output in real-time.

7. The method of claim 1 further comprising enabling a user to perform resolution scaling, cropping and/or file-type conversion of the submitted media.

8. The method of claim 1 further comprising integrating the media submission system with a marketing network.

9. The method of claim 8 wherein the marketing network operates across a variety of media types.

10. A method comprising:
operating an online marketing resource system; and
facilitating collaboration of different types of users of the marketing resource system.

11. The method of claim 10 wherein the different types of users include: designers, media vendors, content controllers, and/or end-users.

12. The method of claim 10 wherein marketing media is processed for output based on account types and rules-based interaction between the account types.

13. The method of claim 12 wherein processing of marketing media comprises: constructing, submitting, reviewing, storing, monitoring and/or distributing the marketing media.

14. A method comprising:
deploying marketing media through an online marketing resource system;
collecting and storing empirical marketing data that relates to specific media content deployed through the system; and
correlating the specific media content to target demographics.

15. The method of claim 14 further comprising re-deploying marketing media through the system in response to the correlation.

16. The method of claim 15 wherein the empirical marketing data is obtained through real deployment and/or provided by marketing professionals.

17. The method of claim 15 further comprising creating a stored procedure in response to the correlation between the specific media content and target demographics.

18. The method of claim 14 further comprising matching media content to target demographics as a stored procedure.

19. The method of claim 15 further comprising creating a baseline for a user in response to the correlation.
